(19) United States
(12) Patent Application Publication
(10) Pub. No.: US 2016/0088639 A1
(43) Pub. Date: Mar. 24, 2016

(54) LINK ADAPTATION FOR COORDINATED SCHEDULING

(71) Applicant: QUALCOMM Incorporated, San Diego, CA (US)

(72) Inventors: Andreas Maximilian Schenk, Erlangen (DE); Andrea Garavaglia, Nuremberg (DE); Vinay Chande, San Diego, CA (US); Chirag Sureshbhai Patel, San Diego, CA (US)

(21) Appl. No.: 14/492,998

(22) Filed: Sep. 22, 2014

(51) Int. Cl. H04W 72/08

(52) U.S. Cl. CPC H04W 72/085

(57) ABSTRACT

Described herein are techniques for link adaptation at an access point enabled for coordinated scheduling. For example, the technique may involve determining a resource-allocation profile (RAP) for the access point, wherein the RAP is based on a set of statistics associated with channel conditions for mobile devices. The technique may involve determining a plurality of link adaptation instances configured for managing interference, each link adaptation instance being associated with an interference condition. The technique may involve for each link adaptation instance, updating the link adaptation instance based on statistics associated with the interference condition.

### BACKGROUND

Aspects of the present disclosure relate generally to wireless communication systems, and more particularly, to link adaptation used for coordinated scheduling and/or coordinated beamforming.

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

A wireless communication network may include a number of access point that can support communication for a number of mobile devices, such as, for example, mobile stations (STA), laptops, cell phones, PDAs, tablets, etc. A STA may communicate with an access point via the downlink (DL) and uplink (UL). The DL (or forward link) refers to the communication link from the access point to the STA, and the UL (or reverse link) refers to the communication link from the STA to the access point.

### SUMMARY

Methods and apparatus for link adaptation in an apparatus configured for coordinated scheduling and/or coordinated beamforming are described in detail in the detailed description, and certain aspects are summarized below. This summary and the following detailed description should be interpreted as complementary parts of an integrated disclosure, which parts may include redundant subject matter and/or supplemental subject matter. An omission in either section does not indicate priority or relative importance of any element described in the integrated application. Differences between the sections may include supplemental disclosures of alternative embodiments, additional details, or alternative descriptions of identical embodiments using different terminology, as should be apparent from the respective disclosures.

In an aspect, a method is provided for wireless communication at an access point enabled for coordinated scheduling. The method includes determining a resource-allocation profile (RAP) for the access points, wherein the RAP is based on a set of statistics associated with channel conditions for mobile devices. The method includes determining a plurality of link adaptation instances configured for managing interference, each link adaptation instance being associated with an interference condition. The method includes for each link adaptation instance, updating the link adaptation instance based on statistics associated with the interference condition.

In another aspect, an apparatus enabled for coordinated scheduling is provided for link adaptation in a wireless communication system. The apparatus includes means for determining a resource-allocation profile (RAP) for the access point, wherein the RAP is based on a set of statistics associated with channel conditions for mobile devices. The apparatus includes means for determining a plurality of link adaptation instances configured for managing interference, each link adaptation instance being associated with an interference condition. The apparatus includes means for updating, for each link adaptation instance, the link adaptation instance based on statistics associated with the interference condition.

It is understood that other aspects will become readily apparent to those skilled in the art from the following detailed description, wherein it is shown and described various aspects by way of illustration. The drawings and detailed description are to be regarded as illustrative in nature and not as restrictive.

### BRIEF DESCRIPTION OF THE DRAWINGS

FIG. 1 is a block diagram conceptually illustrating an example of a telecommunications system.

FIG. 2 is a block diagram conceptually illustrating a design of a base station/eNB and a UE configured according to one aspect of the present disclosure.

FIG. 3 illustrates a resource allocation profile for a cell serving UEs.

FIG. 4 is a block diagram conceptually illustrating a design for multiple link adaptation instances in a wireless communication system configured for coordinated scheduling.

FIG. 5 is a diagram illustrating an embodiment of link adaptation for coordinated scheduling based on a validity check for an expiry duration.

FIG. 6 is a diagram illustrating an embodiment of link adaptation for coordinated scheduling based on exponential decay of offset values.

FIG. 7 illustrates embodiments of methodologies for link adaptation in an apparatus enabled for coordinated scheduling and/or beamforming

FIG. 8 illustrates an example apparatus for implementing the methodology of FIG. 7.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

The present disclosure relates to techniques for link adaptation for coordinated scheduling and/or coordinated beamforming In centralized or coordinated scheduling for Long Term Evolution (LTE) small cells, the channel conditions may change significantly from one time instance to another depending on the particular interference situation experienced during a scheduled transmission. This additional degree of channel variation may have negative influence on the link adaptation process, if the different interference situations are not taken into account for the link adaptation process. As a consequence, a method is provided for link adaptation based on centralized scheduling decisions. For example, the techniques may include using coordinated scheduling using multiple link adaptation instances with each instance being based on an interference condition.

The techniques described herein may be used for various wireless communication networks such as CDMA, TDMA, FDMA, OFDMA, SC-FDMA and other networks. The terms “network” and “system” are often used interchangeably. A CDMA network may implement a radio technology such as Universal Terrestrial Radio Access (UTRA), CDMA2000, etc. UTRA includes Wideband CDMA (WCDMA) and other variants of CDMA. CDMA2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the wireless networks and radio technologies mentioned above as well as other wireless networks and radio technologies. For clarity, certain aspects of the techniques are described below for LTE, and LTE terminology is used in much of the description below.

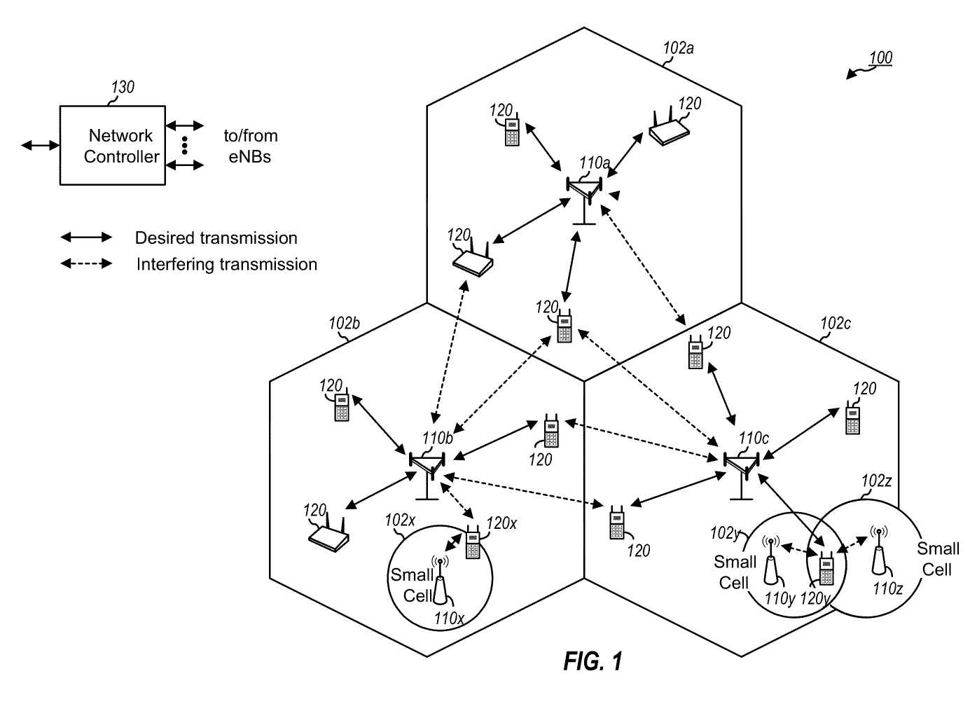

FIG. 1 shows a wireless communication network 100, which may be an LTE network. The wireless network 100 may include a number of eNBs 110 and other network entities. An eNB may be a station that communicates with the UEs and may also be referred to as a base station, a Node B, an access point, or other term. Each eNB 110a, 110b, 110c may provide communication coverage for a particular geographic area. In 3GPP, the term “cell” can refer to a coverage area of an eNB and/or an eNB subsystem serving this coverage area, depending on the context in which the term is used.

An eNB may provide communication coverage for a macro cell or small cell. A small cell may sometimes be referred to as a pico cell, a femto cell, and/or other types of cell. A macro cell may cover a relatively large geographic area (e.g., several kilometers in radius) and may allow unrestricted access by UEs with service subscription. A type of small cell sometimes referred to as a pico cell may cover a relatively small geographic area and may allow unrestricted access by UEs with service subscription. A type of small cell sometimes referred to as a “femto cell” may cover a relatively small geographic area (e.g., a home) and may allow restricted access by UEs having association with the femto cell (e.g., UEs in a Closed Subscriber Group (CSG), UEs for users in the home, etc.). An eNB for a macro cell may be referred to as a macro eNB. An eNB for a small cell may be referred to as a small cell eNB. In the example shown in FIG. 1, the eNBs 110a, 110b and 110c may be macro eNBs for the macro cells 102a, 102b and 102c, respectively. The eNB 110x may be a small cell eNB for a small cell 102x, serving a UE 120x. The eNBs 110y and 110z may be small cell eNBs for the small cells 102y and 102z, respectively. An eNB may support one or multiple (e.g., three) cells. As used herein, a small cell means a cell characterized by having a transmit power substantially less than each macro cell in the network with the small cell, for example low-power access nodes such as defined in 3GPP Technical Report (T.R.) 36.932 section 4.

The wireless network 100 may be a heterogeneous network that includes eNBs of different types, e.g., macro eNBs, small cell eNBs, relays, etc. These different types of eNBs may have different transmit power levels, different coverage areas, and different impact on interference in the wireless network 100. For example, macro eNBs may have a high transmit power level (e.g., 20 Watts) whereas small cell eNBs and relays may have a lower transmit power level (e.g., 1 Watt).

The wireless network 100 may support synchronous or asynchronous operation. Broadcast multicast and centralized/coordinated scheduling operations may require synchronization of base stations within a defined area. For synchronous operation, the eNBs may have similar frame timing, and transmissions from different eNBs may be approximately aligned in time. For asynchronous operation, the eNBs may have different frame timing, and transmissions from different eNBs may not be aligned in time. The techniques described herein may be used for both synchronous and asynchronous operation.

A network controller 130 may couple to a set of eNBs and provide coordination and control for these eNBs. The network controller 130 may communicate with the eNBs 110 via a backhaul. The eNBs 110 may also communicate with one another, e.g., directly or indirectly via wireless or wireline backhaul.

The UEs 120 may be dispersed throughout the wireless network 100, and each UE may be stationary or mobile. A UE may also be referred to as a terminal, a mobile station, a subscriber unit, a station, etc. A UE may be a cellular phone, a personal digital assistant (PDA), a wireless modem, a wireless communication device, a handheld device, a laptop computer, a cordless phone, a wireless local loop (WLL) station, or other mobile devices. A UE may be able to communicate with macro eNBs, small cell eNBs, relays, or other network entities. In FIG. 1, a solid line with double arrows indicates desired transmissions between a UE and a serving eNB, which is an eNB designated to serve the UE on the downlink and/or uplink. A dashed line with double arrows indicates interfering transmissions between a UE and an eNB.

LTE utilizes orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, K may be equal to 128, 256, 512, 1024 or 2048 for system bandwidth of 1.25, 2.5, 5, 10 or 20 megahertz (MHz), respectively. The system bandwidth may also be partitioned into subbands. For example, a subband may cover 1.08 MHz, and there may be 1, 2, 4, 8 or 16 subbands for system bandwidth of 1.25, 2.5, 5, 10 or 20 MHz, respectively.

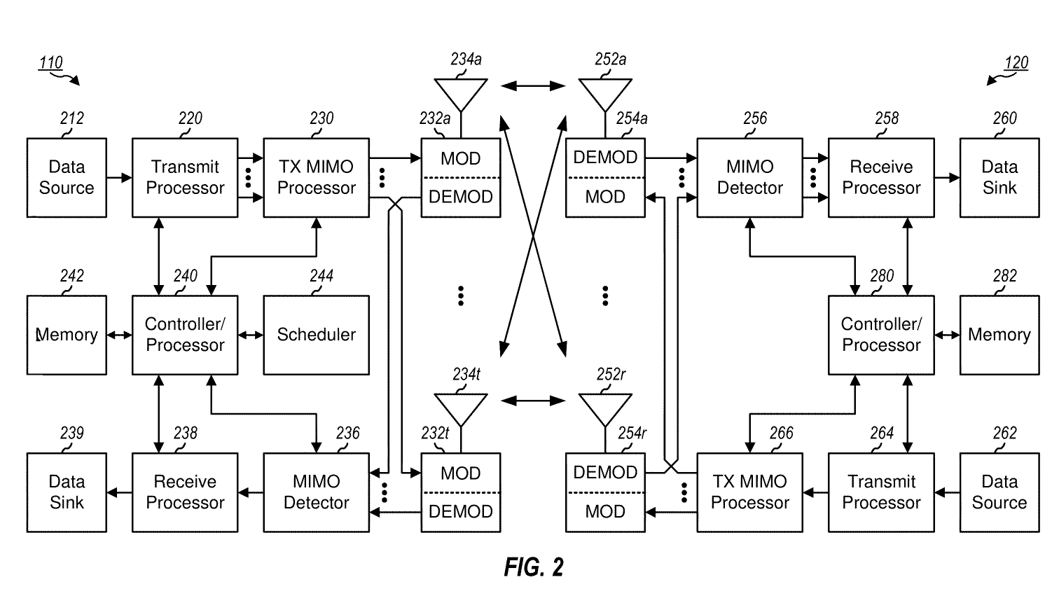

FIG. 2 shows a block diagram of a design of a base station/eNB 110 and a UE 120, which may be one of the base stations/eNBs and one of the UEs in FIG. 1. The base station 110 may be equipped with antennas 234a through 234t, and the UE 120 may be equipped with antennas 252a through 252r.

At the base station 110, a transmit processor 220 may receive data from a data source 212 and control information from a controller/processor 240. The control information may be for the PBCH, PCFICH, PHICH, PDCCH, etc. The data may be for the PDSCH, etc. The processor 220 may process (e.g., encode and symbol map) the data and control information to obtain data symbols and control symbols, respectively. The processor 220 may also generate reference symbols, e.g., for the PSS, SSS, and cell-specific reference signal. A transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) 232a through 232t. Each modulator 232 may process a respective output symbol stream (e.g., for OFDM, etc.) to obtain an output sample stream. Each modulator 232 may further process (e.g., convert to analog, amplify, filter, and upconvert) the output sample stream to obtain a downlink signal. Downlink signals from modulators 232a through 232t may be transmitted via the antennas 234a through 234t, respectively.

At the UE 120, the antennas 252a through 252r may receive the downlink signals from the base station 110 and may provide received signals to the demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. A MIMO detector 256 may obtain received symbols from all the demodulators 254a through 254r, perform MIMO detection on the received symbols if applicable, and provide detected symbols. A receive processor 258 may process (e.g., demodulate, deinterleave, and decode) the detected symbols, provide decoded data for the UE 120 to a data sink 260, and provide decoded control information to a controller/processor 280.

On the uplink, at the UE 120, a transmit processor 264 may receive and process data (e.g., for the PUSCH) from a data source 262 and control information (e.g., for the PUCCH) from the controller/processor 280. The processor 264 may also generate reference symbols for a reference signal. The symbols from the transmit processor 264 may be precoded by a TX MIMO processor 266 if applicable, further processed by the modulators 254a through 254r (e.g., for SC-FDM, etc.), and transmitted to the base station 110. At the base station 110, the uplink signals from the UE 120 may be received by the antennas 234, processed by the demodulators 232, detected by a MIMO detector 236 if applicable, and further processed by a receive processor 238 to obtain decoded data and control information sent by the UE 120. The processor 238 may provide the decoded data to a data sink 239 and the decoded control information to the controller/processor 240.

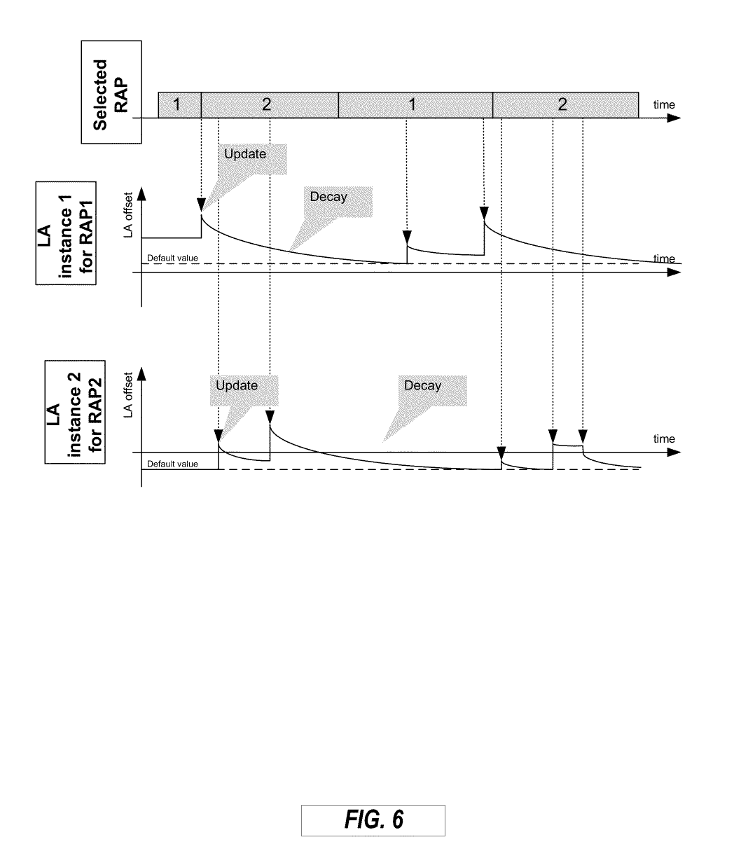

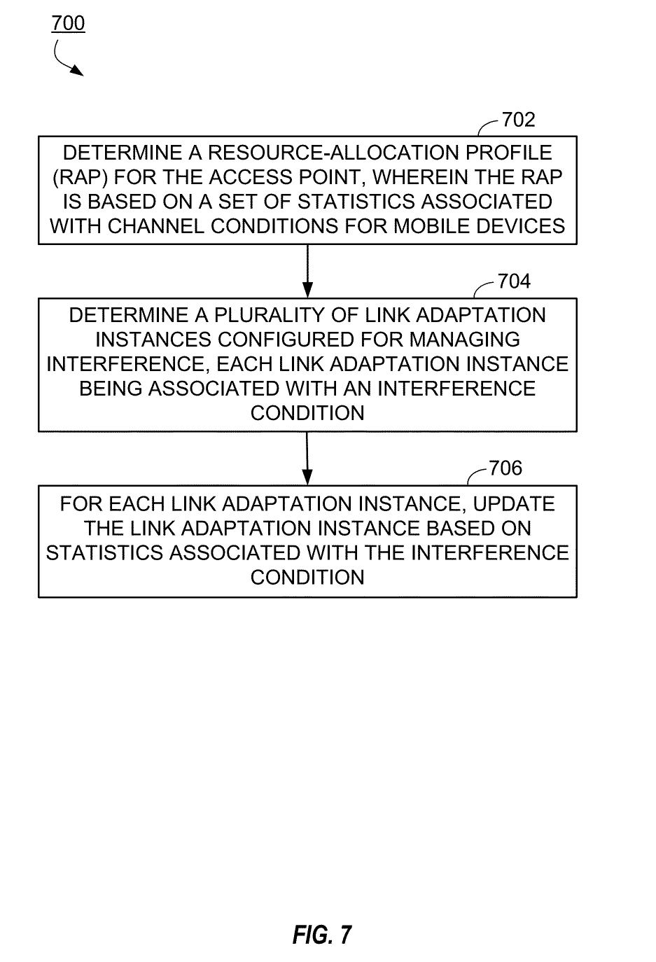

The controllers/processors 240 and 280 may direct the operation at the base station 110 and the UE 120, respectively. The processor 240 and/or other processors and modules at the base station 110 may perform or direct the execution of various processes for the techniques described herein, such as the functional blocks illustrated in FIG. 7. The processor 280 and/or other processors and modules at the UE 120 may also perform or direct the execution of the functional blocks illustrated in FIG. 6, and/or other processes for the techniques described herein. The memories 242 and 282 may store data and program codes for the base station 110 and the UE 120, respectively. A scheduler 244 may schedule UEs for data transmission on the downlink and/or uplink.

In one configuration, the eNB 110 for wireless communication may include means for performing the processes illustrated in FIG. 7. For example, the eNB 110 may include means for determining a RAP for the access point, wherein the RAP is based on a set of statistics associated with channel conditions for mobile devices. For example, the eNB 110 may include means for determining a plurality of link adaptation instances configured for managing interference, each link adaptation instance being associated with an interference condition. For example, the eNB 110 may include means for updating, for each link adaptation instance, the link adaptation instance based on statistics associated with the interference condition. In one aspect, the aforementioned means may be the processor(s), the controller/processor 240, and the memory 242 configured to perform the functions recited by the aforementioned means. In another aspect, the aforementioned means may be a module or any apparatus configured to perform the functions recited by the aforementioned means.

For densely deployed LTE networks, coordinated scheduling and/or coordinated beamforming (hereafter “CS”) among neighboring cells (eNBs) may be a promising candidate to adaptively manage and control interference in the entire network.

CS may consist of the following steps. CS may include collection of channel measurements (e.g., CQI) of UEs connected to cells associated to the CS in a CS controller (e.g., one of the eNBs acts as master/CS-controller). CS may include a decision process for determining or selecting which cells should be active and/or which UEs should be served on an upcoming time and/or frequency resource (in a so-called resource-allocation profile, RAP). Typically the CS decision may be based on network-wide scheduling metrics which may take into account the interference situation in the entire network. CS may include communication of the CS decision (RAP) to the cells, and then application of the CS decision at the cells and/or UEs.

Selection of transport block format may include, in particular, selection of the modulation and coding scheme (MCS) and the rank for the scheduled transmission based on outer control loops (so-called link adaptation, LA). Depending on the implementation of CS, LA may be performed in the CS-controller or the cell serving the UE.

LA may adjust the reported CQI reports by applying an offset to the (possibly filtered) value reported by the UE (in downlink) or value measured in the cell (in uplink).

The LA offset may be updated based on an outer control loop, e.g., based on ACKs/NACKs of prior HARQ transmissions or other statistics, in order to control certain characteristics of the scheduled transmissions, e.g., target error rates of the first HARQ attempt.

In CS, on top of conventional sources of varying channel conditions such as fast fading, the channel conditions may change significantly from one time instance to another, depending on the particular interference situation experienced during the scheduled transmission (for downlink terminated at the UE, for uplink terminated at the eNB). As an example, in the case where a data transmission to a UE has been scheduled in an interference-free condition in subframe ‘n’ (all neighboring cells muted), and in subframe ‘n+1’ it may be scheduled in the presence of transmissions of all neighboring cells, i.e., experiences significant interference. This additional degree of channel variation potentially has negative influence on the link adaptation process. In particular, the MCS and/or rank may not be properly selected to meet desired properties of the transmission (e.g., target error rate of first HARQ transmission) because the LA offset may not be valid for the new interference situation.

As a consequence, link adaptation should take into account CS decisions.

An embodiment may include implementing and maintaining multiple independent LA instances for each (relevant) interference situation instead of only a single LA instance. There may be up to 2̂ (N-1) interference instances for LA, with one LA instance for each RAP in which the scheduled UE is active. N denotes the number of cells under control of CS. The number of LA control loops may be reduced further, e.g., with independent LA instances only for the groups of RAPs significant for the controlled UE or including independent LA instances only for groups of RAPs for which the UE reports CQI feedback. For example, in LTE Release 11, up to 4 Channel State Information (CSI) processes can run simultaneously in each UE with CQI information bucketed into two independent groups (‘subframe sets’). In this respect, 4*2=8 LA instances can be maintained.

The number of LA control loops may be reduced further, such that there are only two independent LA instances associated to two groups of RAPs, one for low interference and one for high interference experienced by the UE. Each LA instance may be updated based on statistics corresponding to the associated interference situation (e.g., RAP-group). In addition, updates based on statistics of RAP-groups leading to similar interference situations may be taken into account, as well.

Each LA instance may include a memory element in order to implement a forgetting factor in case the associated interference situation has not been used for a period of time (and/or the LA instance has not been updated). This may be implemented as an exponential decay towards a default offset value or as a configurable expiry duration, after which the back-off value of LA expires and a default offset value is used. The default offset value may be set depending on the associated RAP-group.

As an example, the default value for a RAP causing low interference to the UE could be optimistic. The default offset value may be adjusted based on information of other LA instances which were updated recently. The default offset value may be adjusted based on the history of selected RAPs. As an example, if the UE is scheduled mainly in high-interference conditions, also for all other RAPs an optimistic value could be used. Each LA instance may be configured with different target criteria (e.g., target error rate of the first HARQ attempt). As an example, the LA instance for RAPs where the transmission experiences low interference may be more aggressive compared to those which experience high interference.

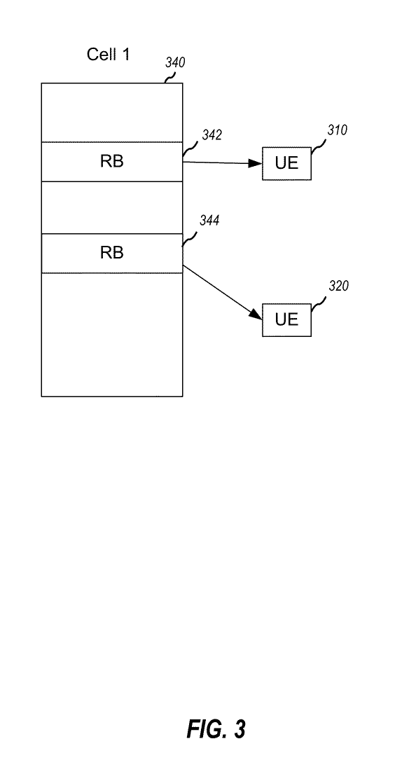

FIG. 3 illustrates a resource allocation profile for a cell serving UEs. For example, the cell 340 may have resource blocks (RBs) 342, 344 allocated to one or more UEs 310, 320. For example, one RB 342 may be allocated to one UE 310. Another RB 344 may be allocated to another UE 320. The set of allocations of the RBs to the UEs may be considered a RAP.

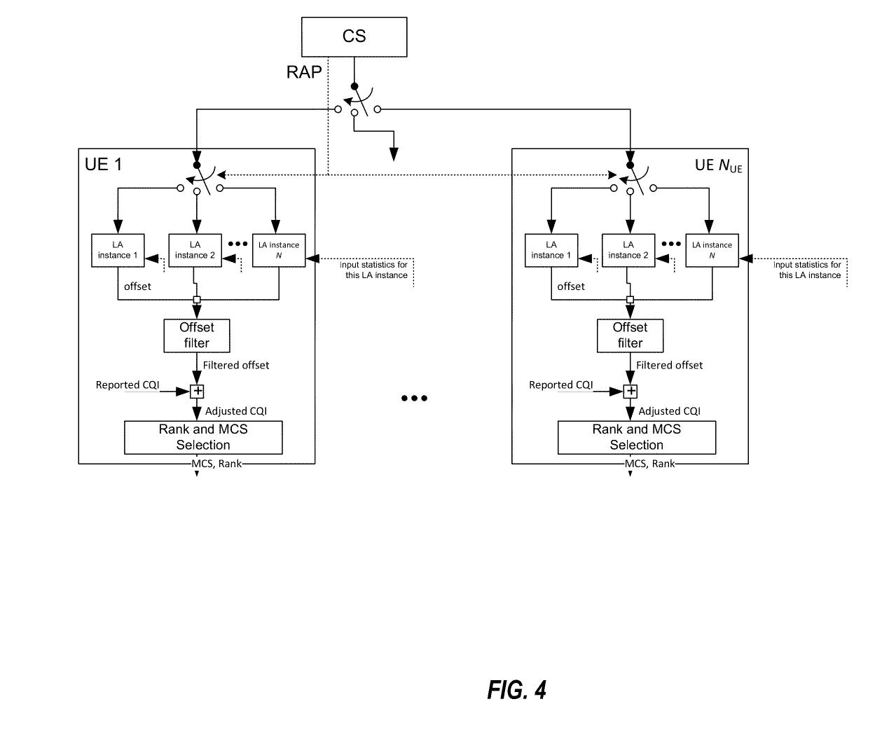

In FIG. 4, the operation of LA may include multiple LA instances. The instances UE 1 to UE N_{UE} may be module (hardware or software) in the cell for the particular UE. In an example, for UE 1, the cell may use the RAP and perform LA based on a target criteria (e.g., target error rate).

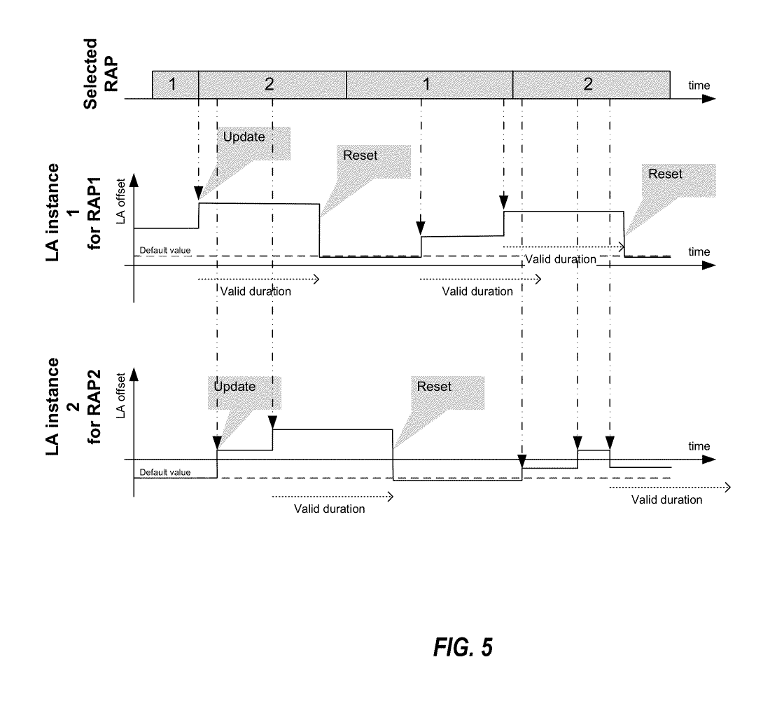

In one embodiment for LA, illustrated in FIG. 5, the forgetting element may include a memory element for performing a validity check. For example, the check may be based on a validity or expiry duration. At the start (left side of time line) a default value may be used for the LA offset. The LA offset may be updated (e.g., based on a control loop of ACKs/NACKs). The updated LA offset may be valid for a pre-determined time duration. A memory and/or a clock may keep track of the validity duration. At the expiration of the validity duration, the LA offset may be reset, e.g., to the default value.

In another embodiment for LA, illustrated in FIG. 6, the forgetting element may include a memory element for performing an exponential decay function. For example, the decay function may cause the offset value to decay (or approach) the default value over a period of time. At the start (left side of time line) a default value may be used for the LA offset. The LA offset may be updated (e.g., based on a control loop of ACKs/NACKs). The updated LA offset may decay to the default value. The parameters of the decay may be predetermined, configured, or determined based on runtime variables.

The concept may be extended to handle multiple sub-bands (part of frequency resources) with independent LA instances for each RAP and sub-band. The concept may be applicable for CS in the downlink and the uplink. In the uplink, LA may directly operate on the measured channel quality as opposed to the reported CQI in the downlink.

FIG. 7 illustrates embodiments of methodologies for link adaptation for coordinated scheduling. The method may be performed by an access point, eNB, small cell, or the like. The method 700 may include, at 702, determining a RAP for the access point, wherein the RAP is based on a set of statistics associated with channel conditions for mobile devices. The method 700 may include determining a plurality of link adaptation instances configured for managing interference, each link adaptation instance being associated with an interference condition, at 704. The method 700 may include for each link adaptation instance, updating the link adaptation instance based on statistics associated with the interference condition, at 706.

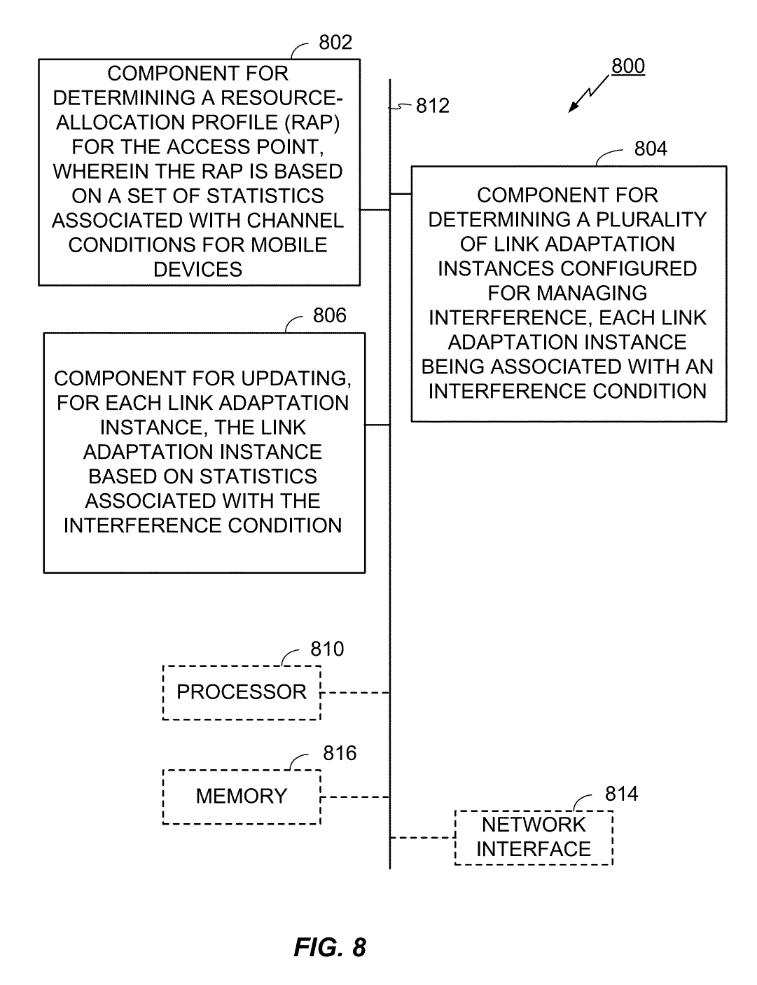

With reference to FIG. 8, there is provided an exemplary apparatus 800 that may be configured as an access point, eNB, small cell, or other suitable entity, or as a processor, component or similar device for use within the access point, or other suitable entity, for link adaptation. The apparatus 800 may include functional blocks that can represent functions implemented by a processor, software, or combination thereof (e.g., firmware).

As illustrated, in one embodiment, the apparatus 800 may include an electrical component or module 802 for determining a RAP for the access point, wherein the RAP is based on a set of statistics associated with channel conditions for mobile devices. The apparatus 800 may include an electrical component or module 804 for determining a plurality of link adaptation instances configured for managing interference, each link adaptation instance being associated with an interference condition. The apparatus 800 may include an electrical component or module 806 for updating, for each link adaptation instance, the link adaptation instance based on statistics associated with the interference condition.

In related aspects, the apparatus 800 may optionally include a processor component 810 having at least one processor, in the case of the apparatus 800 configured as a network entity. The processor 810, in such case, may be in operative communication with the components 802-806 or similar components via a bus 812 or similar communication coupling. The processor 810 may effect initiation and scheduling of the processes or functions performed by electrical components or modules 802-806.

In further related aspects, the apparatus 800 may include a network interface component 814 for communicating with other network entities. The apparatus 800 may optionally include a component for storing information, such as, for example, a memory device/component 816. The computer readable medium or the memory component 816 may be operatively coupled to the other components of the apparatus 800 via the bus 812 or the like. The memory component 816 may be adapted to store computer readable instructions and data for performing the activity of the components 802-806, and subcomponents thereof, or the processor 810. The memory component 816 may retain instructions for executing functions associated with the components 802-806. While shown as being external to the memory 816, it is to be understood that the components 802-806 can exist within the memory 816.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection may be properly termed a computer-readable medium to the extent involving non-transient storage of transmitted signals. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium, to the extent the signal is retained in the transmission chain on a storage medium or device memory for any non-transient length of time. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method for wireless communication at an access point enabled for coordinated scheduling, the method comprising:
determining a resource-allocation profile (RAP) for the access point, wherein the RAP is based on a set of statistics associated with channel conditions for mobile devices;
determining a plurality of link adaptation instances configured for managing interference, each link adaptation instance being associated with an interference condition; and
updating each link adaptation instance of the plurality of link adaptation instances based on statistics associated with the interference condition.

2. The method of claim 1, for each link adaptation instance, selecting a modulation and coding scheme (MCS) and rank for transmission based on the link adaptation instance.

3. The method of claim 1, further comprising determining a target criteria for each link adaptation instance, wherein the target criteria comprises a quality metric including target error rate and data throughput.

4. The method of claim 1, further comprising converging an offset value for a given link adaptation instance toward a default value for each time period the given link adaptation instance is idle.

5. The method of claim 4, wherein converging the offset value for the given link adaptation instance comprises:
storing a current value of the given link adaptation instance in a cache; and
one of incrementing or decrementing the current value by a predetermined value to converge toward the default value.

6. The method of claim 4, wherein converging the offset value for the given link adaptation instance comprises:
starting a timer indicating a validity time period of the offset value; and
resetting the offset value to the default value upon expiration of the timer.

7. The method of claim 1, wherein determining the RAP comprises receiving the RAP from a master node configured for determining a set of RAP for a plurality of access points.

8. The method of claim 1, further comprising collecting the set of statistics associated with channel conditions for the mobile devices via measurement reports, wherein determining the RAP is based on the collected set of statistics.

9. The method of claim 1, wherein the plurality of link adaptation instances comprises a number of instances not exceeding 2̂ (N-1), where N is a number of access points under control of the coordinated scheduling.

10. The method of claim 9, wherein the number of instances is based on a grouping of RAPs significant for a given mobile device.

11. The method of claim 9, wherein the number of instances is based on a grouping of RAPs for which a given mobile device reports channel quality indications (CQI) feedback.

12. The method of claim 9, wherein the number of instances one group of RAPs comprising nodes associated with low interference, and one group of RAPs comprising nodes associated with high interference.

13. The method of claim 2, wherein selecting the MCS comprises one of selecting MCS for downlink or uplink transmissions.

14. A wireless communication apparatus enabled for coordinated scheduling, the apparatus comprising:
means for determining a resource-allocation profile (RAP) for the access point, wherein the RAP is based on a set of statistics associated with channel conditions for mobile devices;
means for determining a plurality of link adaptation instances configured for managing interference, each link adaptation instance being associated with an interference condition;
means for updating each link adaptation instance of the plurality of link adaptation instances based on statistics associated with the interference condition.

15. The apparatus of claim 14, further comprising means for selecting, for each link adaptation instance, a modulation and coding scheme (MCS) and rank for transmission based on the link adaptation instance.

16. The apparatus of claim 14, further comprising means for determining a target criteria for each link adaptation instance, wherein the target criteria comprises a quality metric including target error rate and data throughput.

17. The apparatus of claim 14, further comprising means for converging an offset value for a given link adaptation instance toward a default value for each time period the given link adaptation instance is idle.

18. The apparatus of claim 17, wherein converging the offset value for the given link adaptation instance comprises:
storing a current value of the given link adaptation instance in a cache;
one of incrementing or decrementing the current value by a predetermined value to converge toward the default value.

19. The apparatus of claim 17, wherein converging the offset value for the given link adaptation instance comprises:
starting a timer indicating a validity time period of the offset value; and
resetting the offset value to the default value upon expiration of the timer.

20. An apparatus for identifying an access network in a wireless communication system, the apparatus comprising:
at least one processor configured for:
(i) determining a resource-allocation profile (RAP) for the access point, wherein the RAP is based on a set of statistics associated with channel conditions for mobile devices, (ii) determining a plurality of link adaptation instances configured for managing interference, each link adaptation instance being associated with an interference condition, and (iii) updating each link adaptation instance of the plurality of link adaptation instances based on statistics associated with the interference condition; and
a memory coupled to the at least one processor for storing data.

21. The apparatus of claim 20, wherein the at least one processor is further configured for selecting, for each link adaptation instance, a modulation and coding scheme (MCS) and rank for transmission based on the link adaptation instance

22. The apparatus of claim 20, wherein the at least one processor is further configured for determining a target criteria for each link adaptation instance, wherein the target criteria comprises a quality metric including target error rate and data throughput.

23. The apparatus of claim 20, wherein the at least one processor is further configured for converging an offset value for a given link adaptation instance toward a default value for each time period the given link adaptation instance is idle.

24. The apparatus of claim 20, wherein converging the offset value for the given link adaptation instance comprises:
storing a current value of the given link adaptation instance in a cache; and
one of incrementing or decrementing the current value by a predetermined value to converge toward the default value.

25. The apparatus of claim 24, wherein converging the offset value for the given link adaptation instance comprises:
starting a timer indicating a validity time period of the offset value; and
resetting the offset value to the default value upon expiration of the timer.

26. A computer program product comprising:
a non-transitory computer-readable medium storing code for causing at least one computer to:
determine a resource-allocation profile (RAP) for the access point, wherein the RAP is based on a set of statistics associated with channel conditions for mobile devices;
determine a plurality of link adaptation instances configured for managing interference, each link adaptation instance being associated with an interference condition; and
update each link adaptation instance of the plurality of link adaptation instances based on statistics associated with the interference condition.

27. The computer program product of claim 26, wherein the non-transitory computer-readable medium further stores code for causing the at least one computer to determine a target criteria for each link adaptation instance, wherein the target criteria comprises a quality metric including target error rate and data throughput.

28. The computer program product of claim 26, wherein the non-transitory computer-readable medium further stores code for causing the at least one computer to converge an offset value for a given link adaptation instance toward a default value for each time period the given link adaptation instance is idle.

29. The computer program product of claim 28, wherein converging the offset value for the given link adaptation instance comprises:
storing a current value of the given link adaptation instance in a cache; and
one of incrementing or decrementing the current value by a predetermined value to converge toward the default value.

30. The computer program product of claim 28, wherein converging the offset value for the given link adaptation instance comprises:
starting a timer indicating a validity time period of the offset value; and
resetting the offset value to the default value upon expiration of the timer.
